(19) United States
(12) Patent Application Publication
(10) Pub. No.: US 2007/0294676 A1
(43) Pub. Date: Dec. 20, 2007

(54) Open virtual appliance

(76) Inventors: Ewan Ellis Mellor, Cambridge (GB); Andrew Kent Warfield, Vancouver (CA)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/820,252

(22) Filed: Jun. 19, 2007

Related U.S. Application Data
(60) Provisional application No. 60/814,819, filed on Jun. 19, 2006.

(51) Int. Cl. G06F 9/45

(52) U.S. Cl. 717/139

(57) ABSTRACT

An open virtual appliance is a transport mechanism allowing virtual appliances to be performed upon various virtual environments, even where the formatting of the virtual appliance and virtual environment are not similar. The open virtual appliance provides a common, flexible packaging format for virtual machines that guide their management throughout all stages of a virtual machines life cycle.

### FIELD OF THE INVENTION

The present invention generally relates to the field of virtual computing and software administration and management, and particularly to the instantiation of application appliances through virtual machines.

### BACKGROUND OF THE INVENTION

Virtual machines (VMs) have attracted a great deal of attention lately for their potential to achieve better utilization of computer hardware while simultaneously isolating coarse-grained units of application software such as web servers, virus scanners, and email clients. Isolating applications into individual VMs allows failure to be contained, enhances system security, and eases administration. Virtual machines provide a means to build virtual appliances: complete applications, including customized Operating Systems (OSes), placed inside VM containers and administered as black boxes. Software developers may construct such VM-based appliances and ship completely customized software stacks to their customers.

### SUMMARY OF THE INVENTION

The present invention provides an Open Virtual Appliance (OVA) that establishes a common, flexible packaging format for Virtual Machines (VMs). The OVA guides the VMs management throughout all four stages of their life cycle: Development, Deployment, Maintenance, and Removal.

In an exemplary embodiment of the present invention, a packaging format for a virtual machine includes an executable instruction set, including virtual machine specific information, for guiding the management of the virtual machine throughout the virtual machine's life cycle.

Another exemplary embodiment of the present invention provides a method for constructing a packaging format for a virtual machine that comprises creating an executable instruction set, including virtual machine specific information, for guiding the management of the virtual machine throughout the virtual machine's life cycle.

An exemplary embodiment of the present invention includes a system for instantiation of a virtual machine within a virtual environment. The system includes a packaging format for a virtual machine having an executable instruction set, including virtual machine specific information, for guiding the management of the virtual machine throughout the virtual machine's life cycle and a virtual environment for executing the instruction set and instantiating the virtual machine within the virtual environment.

In an exemplary embodiment of the present invention, an executable instruction set for a packaging format of a virtual machine is provided. The instruction set includes a first instruction providing a memory for the virtual machine and a second instruction providing the location of a source file for the virtual machine.

In yet another exemplary embodiment of the invention, an open virtual appliance includes a packaging format for a virtual machine, wherein the packaging format guides the management of the virtual machine throughout the virtual machine's life cycle.

An exemplary embodiment of the invention provides a method of formatting a virtual machine. The method includes the steps of providing a virtual machine and then associating the virtual machine with a packaging format, including virtual machine specific information, for guiding the management of the virtual machine throughout the virtual machine's life cycle.

It is to be understood that both the foregoing general description and the following detailed description are exemplary and explanatory only and are not restrictive of the invention.

### DESCRIPTION OF THE DRAWINGS

The above and other features, aspects, and advantages of the present invention are considered in more detail, in relation to the following description of embodiments thereof shown in the accompanying drawings, in which:

FIG. 1 provides a graphical illustration of a single OVA utilized in a virtual environment in accordance with the principles of the current invention.

FIG. 2 provides a graphical illustration of a virtual environment in which multiple OVAs are being utilized in accordance with the principles of the current invention.

FIG. 3 is an illustration of a block diagram representation of a method for creating an OVA in accordance with the principles of the current invention.

FIG. 4 provides a graphical representation of an exemplary system that includes and OVA and a network in accordance with the principles of the current invention.

FIG. 5 is an illustration of a block diagram representation of an executable instruction set for a packaging format of a virtual machine in accordance with the principles of the current invention.

FIG. 6 is an illustration of a block diagram representation of a method of formatting a virtual machine in accordance with the principles of the current invention.

### DETAILED DESCRIPTION OF THE INVENTION

The invention summarized above may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

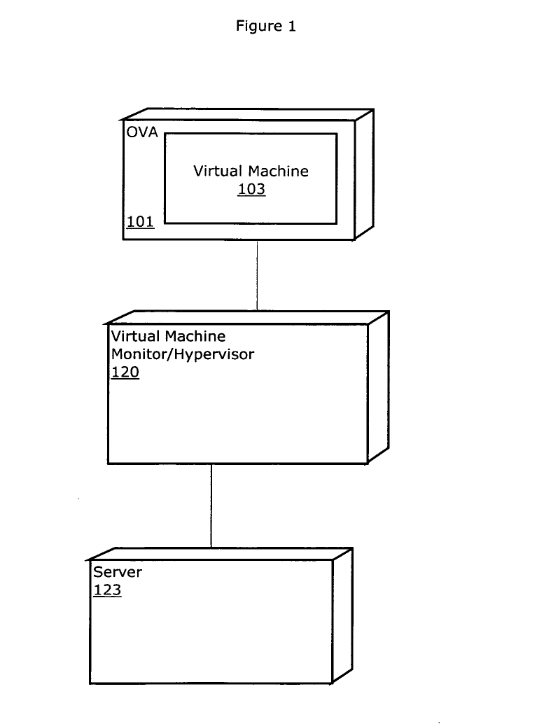

The present invention provides an Open Virtual Appliance (OVA) that establishes a common, flexible packaging format for Virtual Machines (VMs). The OVA guides the VMs management throughout all four stages of their life cycle: Development, Deployment, Maintenance, and Removal. As illustrated in FIG. 1, an OVA 101 is a packaging format for virtual machines 103 (VMs) or virtual appliances. A virtual appliance may include one or more virtual machines 103. The VM 103 conducts specific tasks contemplated by the manufacturer of the virtual appliance. It is contemplated that the number of applications within the VM 103 may vary. In some instances, the VM 103 may only include an operating system. In other instances the VM 103, may include an application and an operating system or an application and an emulator providing an operating environment for the application. The VMs described within the OVA 101 may be instantiated on any virtual platform (i.e., VMM, hypervisor, or other virtualization component) 120 with an OVA compatible installer. The present invention allows VMM manufacturers to create OVA installers compatible with their particular VMMs 120. The OVA compatible installer may utilize the information provided by the OVA 101 to install the VMs 103 on the VMM 120. The VMM 120 allocates the server's 123 resources that the VM requires for operation.

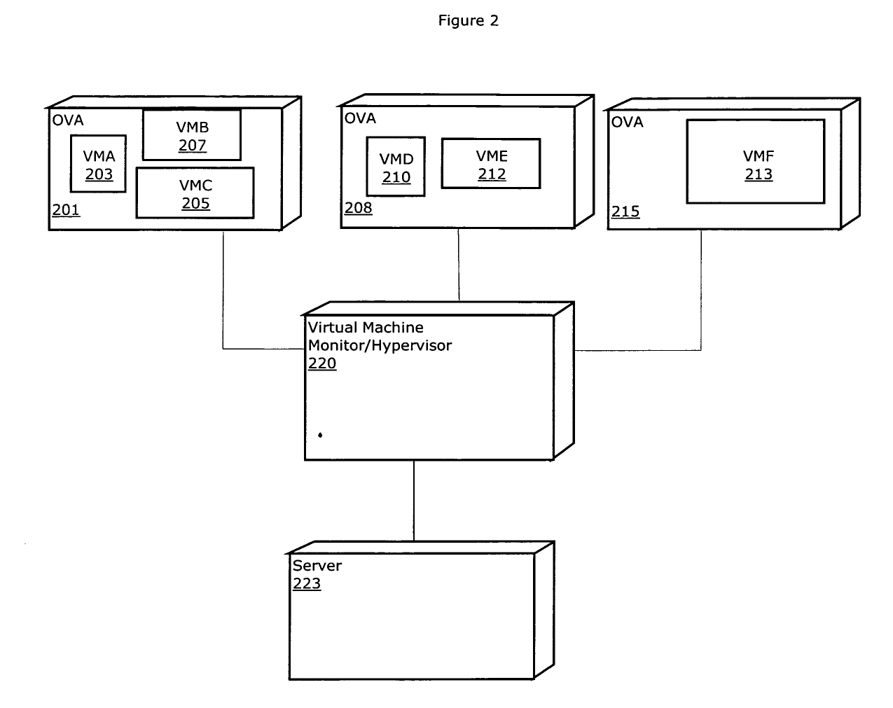

Another embodiment of the present invention is presented in FIG. 2, where a system with multiple VMs packaged in three different OVAs is illustrated. A first OVA 201 may be composed of three VMs (VMA 203, VMB 205, and VMC 207). A second OVA 208 may be composed of an two VMs (VMD 210 and VME 212). A third OVA 215 may be composed of a single virtual machine VMF 213. It is contemplated that the VMs may be formatted in different available formats. For example VMA 203, VMD, 210, and VMF 213 may be in a QCOW package, while VMB 207 and VME are in VMDK, and VME 212 is in a VHD format. All three OVAs may instantiate each VMs so that it may operate in the virtual environment managed by a VMM 220 in the same manner that was explained in FIG. 1.

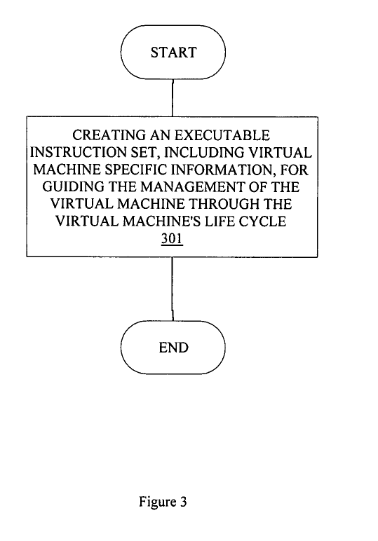

A further embodiment of the present invention presents a method for creating OVAs as provided in FIG. 3. The method involves one step of creating an executable instruction set, including virtual machine specific information, for guiding the management of the virtual machine throughout the virtual machine's life cycle 301. The OVA manufacturer creates the OVA by creating an executable instruction set (e.g., an xml file), including VM specific information (i.e. metadata), for directing installation in a virtual environment of the VMs that the OVA encompasses. The set of instructions also includes directions for managing the VM through the remaining stages of its life cycle (i.e., maintenance and removal). The method further provides that the OVA may include one or more VMs. The method contemplates that the set of instructions (e.g., the xml file) may include directions for obtaining VM components from specified locations such as the file path, network address, http: address, https: address, or any other source a person of ordinary skill in the art may utilize for storing VM components. The method also allows for a security feature to be included in the OVA (e.g., manifest and signature files). The security feature may include a security verification file including a list of security information for each component of the OVA. Additionally, the instruction set may further include directions for updating and/or customizing the OVA and/or the VMs it encompasses.

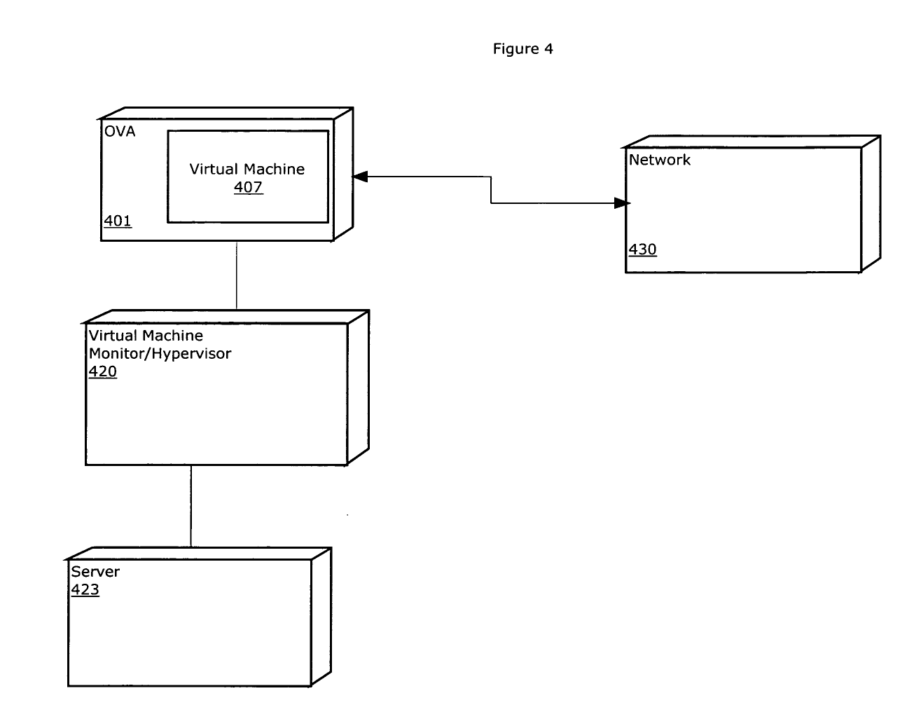

Another embodiment of the present invention, as described in FIG. 4, includes a system for exercising an OVA 401. Where the system includes the OVA 403, installed on a VMM 420 that is communicatively coupled with a network 430 that may provide the components of the VM (OS 403 and applications 407 and 405) encompassed by the OVA 401.

Once a virtual machine is installed, an OVA adds to the user of the VM a self-contained, self-consistent, complete software solution for achieving a particular goal. It is contemplated that the installation of the OVA may occur at various times during the development of the software appliance. An OVA may include a fully-functional and tested web-server/database/OS combination, such as a LAMP stack (Linux® (Linus Torvalds, Portland, Oreg., U.S.)+Apache+MySQL®(MySQL AB, Knivsta, Sweden)+PHP), it may contain a virus checker, including its update software, spyware detector, or it may contain any other specific

The OVA allows for the transport of virtual machine templates containing VM specific information (e.g., metadata) that directs the VMM to allocate appropriate resources (such as memory, filesystems, virtual disk images, and others) for the virtual appliance and install the VM in the virtual environment. In a preferred embodiment, an OVA is installed before it may be run and direct installation, maintenance, or removal of the virtual machines. Once the OVA is installed, the VMs it encompasses are installed on the virtual environment and may run directly out of that environment.

Currently available formatting appliances, such as VMware's Virtual Disk Format (VMDK), Microsoft's Virtual Hard Disk (VHD) format, and others are run-time Virtual Disk Image (VDI) formats operated at the scope of a single VM disk. These formats are not useful if a VM has multiple disks, or for multiple VMs. The OVA allows a software developer to utilize any of these run-time formats, as the OVA compatible installer, which may be created by each platform manufacturer in light of the OVA described in this application, permits the platform to communicate and obtain information from the different types of VDI formats available to the OVA installer.

At installation, the OVA may allow customization of the virtual environment to be utilized by the VM. The OVA may present the end-user with questions related to customization. The OVA may also collect information from the VMM in order to customize the Virtual Machine. The OVA of the present invention also allows the VMMs to work with a VM having multiple disks or multiple VMs. In addition, the OVA provided in the present invention permits certification of the delivered software, allowing the VMM to determine the source of a given appliance and to allow the end-user to make the appropriate trust decisions.

The OVA may be constructed so that the appliance is responsible for its own configuration and modification. Thus, the VMM may provide its functionality regardless of whether it is able to read from the appliance's filesystems because of the OVA. This decoupling of platform from appliance allows OVAs to be implemented using different operating systems and installed on any VMM that has an OVA compatible installer. The OVA therefore allows any operating system, VM, and the like to be installed and executed upon any VMM with an OVA compatible installer.

VMs are increasingly used to package, deploy, and run software applications and have a general life cycle within which VM administration is considered. In a preferred embodiment, this life cycle, shown in Illustration 1 below, is divided into four broad stages: Development, Deployment, Maintenance, and Removal. A VM instance may spend the majority of its life in the Maintenance phase where it has been installed into a VMM environment (“virtual environment”) and runs normally. The OVA of the current invention establishes a common, flexible packaging format for VMs that guide their management throughout all four stages of this life cycle.

Illustration 1: VM Life Cycle

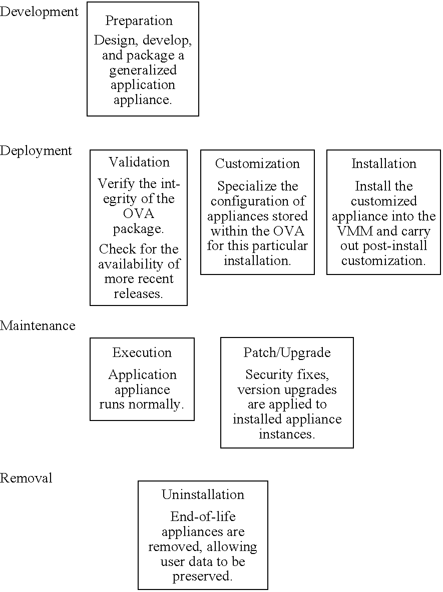

In the Development stage, an OVA is constructed based on one or more existing VMs. Commonly this may involve the construction of a “model” virtual appliance that is to be packaged and distributed. The OVA of the present invention allows such model VMs to be generalized: fixed configuration options in the model VM such as resource limits and network configuration may be associated with parameters that may be set when the OVA is used to install a new virtual appliance instance.

In general, tool support may assist in the packaging and generalization of model virtual appliances into OVAs. Tool support may include libraries for use inside and outside VMs to build each specific VM into a virtual appliance. In one embodiment of the present invention, the tools may be used to specify the mandatory files that make up the OVA. At the end of the development stage, a completed OVA package, which includes the set of instructions for installation, maintenance, and removal in the form of an xml file, the security feature files, and one or more virtual machines (or the instructions to the location where the VMs may be obtained), may be distributed.

The Deployment stage involves the use of an OVA package to instantiate a new application virtual appliance instance on a given VMM-based system. This stage may involve a number of phases. In a preferred embodiment, the Deployment stage is a three phase process. In a first phase, the OVA is validated for integrity and the OVA compatible installer may check for the availability of a newer version of the OVA. In a second phase, the OVA parameters may be set through interactions with system presets and the system administrator in order to customize the instance that is being installed. Finally, in a third phase, the new instance may be installed onto the system, and the new appliance may be started. Post-install configuration may take place as the new appliance is started.

It is to be understood that various validation parameters and techniques may be employed with the OVA of the instant invention without departing from the scope and spirit of the present invention. The customization process may be optional. Various customization tools and techniques may be employed during the installation process. Alternatively, the installation may occur as a separate process after all customization aspects have been applied. It is also contemplated that the installation may occur simultaneously with the customization process(es).

Typically, most of an appliance's lifetime is spent in the Maintenance stage. In this stage, the virtual appliance runs in the system providing functionality to users. The OVA of the present invention allows patching and upgrade of installed applications during this stage in order to fix security vulnerabilities or provide new functionality. The present invention allows for clear separation of user and system data within a virtual appliance description and allows installed virtual appliance images to be upgraded without modifying, damaging, erasing, or corrupting user files. It is contemplated that old OVAs may be replaced with new OVAs, while preserving user data. In addition, the OVA may make backups before upgrade and modify configuration based on previously provided user information. It is further contemplated that the OVA may include various tasks to be performed during the maintenance phase, such as maintaining optimal run-time configuration parameters.

Each OVA may advertise a virtual appliance configuration application, running inside one of the virtual machines. This application may be integrated with OVA management tools, giving the end-user seamless access to in-guest configuration. Developers may be able to add value to their virtual appliances through improvements in the user interface.

The final stage of a virtual appliance's life cycle is that of Removal, in which the virtual appliance is uninstalled from the system. The OVA may address this stage by ensuring that user data generated by the virtual appliance may be preserved safely and complete removal of the appliance from the system, including all configuration data installed during the deployment stage.

In a preferred embodiment, an OVA is a Zip file, such as Info-ZIP, PKZIP, or others as may be contemplated by those of skill in the art. Inside the Zip file there is a file called ova.xml, inside the root directory containing a set of instructions for installation of the OVA and the VMs it encompasses.

In another preferred embodiment of the present invention, the OVA is a POSIX-compatible tar [POSIX.1]. Inside the tar there is a file called ova.xml, within the root directory. This file may be the first entry within the tar file. The encoding and escaping mechanisms described in the ova.xml file are [XML] available. The second entry in the tar file is a manifest.txt within the root directory. Other entries in the tar file's root directory include signatures.asc and mf-signature.asc. In alternative embodiments the tar may include any number of other files.

In a preferred embodiment of the present invention, each directory and file name used within the OVA may be restricted to ASCII characters A-Z, a-z, 0-9, full stop (period), hyphen/minus, and underscore. The directory separator used within written paths is the forward slash “/”, though this may be translated during processing as appropriate to the platform. The filename restrictions described above may apply to the OVA—the appliance filesystems themselves may be populated without any such restrictions.

When ova.xml, manifest.txt, signatures.asc, and mf-signature.asc files are the first four files in the tar, the OVA may be inspected and validated without extracting the entire archive. As a valid POSIX tar archive, the OVA may be created with standard tools, simply by specifying the mandatory files first when creating the archive. On install, the metadata within the ova.xml file are copied to the VMM by its OVA installer.

The following provides a description of two OVA package formats, as described above, through the use of an example case. eSpeil Solutions. These exemplary embodiments describe an OVA containing a customer relationship management (CRM) solution. The virtual appliance of this exemplary embodiment includes three VMs: the eSpeil CRM application, and support VMs containing an Apache web server and a MYSQL® database. During deployment, the OVA customizes system details such as the address of the NTP server to use and installs the virtual appliance onto the system.

In one embodiment of the present invention, the ova.xml file presented below can be stored in a tar or a zip:

```
<?xml version=“1” ?>
<!DOCTYPE appliance PUBLIC “-//OVA//DTD OVA 1//EN”
            “http://www.openvirtualappliance.org/schema/ova-1.dtd”>
<appliance xmlns=‘http://www.openvirtualappliance.org/schema’
            version=“1”>
  <label xml:lang=”en”>eSpiel Sales Solution</label>
  <version>2.1</version>
  <shortdesc xml:lang=”en”>eSpiel Sales Solution</shortdesc>
  <longdesc xml:lang=”en”>
    eSpiel Sales Solution: A CRM, database and webserver packaged
    solution.  http://www.espiel-sales.com/
  </longdesc>
  <detail>
Copyright &copy; 2006 eSpiel Sales Solution Inc.
...
  </detail>
```

| | |
|---|---|
| <manifest | src=“manifest.txt” /> |
| <signature | src=“signature.asc” /> |
| <mf-signature | src=“mf-signature.asc” /> |

```
  <vm name=“crm”>
    <label xml:lang=”en”>eSpiel CRM</label>
    <shortdesc xml:lang=”en”>eSpiel Sales Solution CRM</shortdesc>
    <longdesc xml:lang=”en”>
      eSpiel Sales Solution CRM, running on Debian 3.1, packaged and
      tested by eSpiel.  http://www.espiel-sales.com/
    </longdesc>
    <detail>
Copyright &copy; 2006 eSpiel Sales Solution Inc.
Debian 3.1r2, Mon 17 Apr, 2006.
...
    </detail>
    <config file=“crm.cfg” />
```

| | |
|---|---|
| <vbd fs=“crm-root” | variety=“system” device=”sdal” mode=“w” /> |
| <vbd fs=“backup” | variety=“user” device=”sda2” mode=“w” /> |

```
  </vm>
  <vm name=“mysql”>
    <label xml:lang=“en”>eSpiel MySQL</label>
    ...
    <vbd fs=“mysql-C” variety=“system” device=“C:” mode=“w” />
  </vm>
  <vm>
    <label xml:lang=“en”>eSpiel Apache</label>
    ...
```

| | | |
|---|---|---|
| <vbd fs=“apache-root” | variety=“system” | device=”sda1” |
| mode=“r” /> | | |
| <vbd fs=“backup” | variety=“user” | device=“sda2” |
| mode=“w” /> | | |
| <vbd fs=“apache-cache” | variety=“ephemeral” | device=“sda3” |
| mode=“w” /> | | |

```
  </vm>
  <fs name=“crm-root” source=“file:///crm.qcow”>
    <label xml:lang=”en”>eSpiel CRM Root filesystem</label>
    <shortdesc xml:lang=”en”>...</shortdesc>
    <longdesc xml:lang=”en”>...</longdesc>
    <detail>...</detail>
  </fs>
  <fs name=“mysql-C” source=“file:///mysql.vhd”>
    ...
  </fs>
  <fs name=“apache-root”
      source=“file:///apache-root.tar.bz2”
      type=”ext3” size=“${apache-root-fs-size}”>
    ...
  </fs>
  <fs name=“backup” source=“file:///backup.qcow”>
    ...
  </fs>
  <fs>
  <fs name=“apache-cache” type=“ext3” size=“500MiB”>
    ...
  </fs>
  <properties>
```

| | |
|---|---|
| <property | name=“ntp-server” source=“prompt:ntp-server” /> |
| <property | name=”mysql-root-fs-size” source=”prompt:mysql” /> |
| <property | name=”apache-root-fs-size” source=”script:apache” /> |
| <property | name=”apache-webspace” |
| | source=”script:apache-webspace” /> |
| <property | name=”apache-logspace” |
| | source=”script:apache-logspace” /> |

```
  </properties>
  <prompts>
    <prompt name=“ntp-server” default=“pool.ntp.org”>
      <shortdesc lang=“en”>
        Please specify the address for your NTP server, or use
        pool.ntp.org if you do not have an NTP server
        locally.
      </shortdesc>
    </prompt>
    <prompt name=“mysql” default=“2 GB”>
        <shortdesc xml:lang=”en”>MySQL filesystem size</shortdesc>
      </prompt>
      <prompt name=“apache-webspace”>...</prompt>
      <prompt name=“apache-logspace”>...</prompt>
    </prompts>
    <prompt-values>
      <prompt-value param=”ntp-server” value=“ntp.intra” fixed=“no”
set-by=“Claire Watts” set-on=“2006/04/31 12:13:34“ />
    </prompt-values>
    <scripts>
      <script name=”apache” script=”scripts/apache-root-fs-size.sh”>
        <param>${apache-webspace}</param>
        <param>${apache-logspace}</param>
      </script>
      <script name=“registration” script=“scripts/registration.sh”>
      </script>
      <aux-file>scripts/common.sh</aux-file>
    </scripts>
    <hooks>
      <hook event=”post-install” script=”registration” />
    </hooks>
    <admin vm=“crm” port=“8088” patch=“/” />
</appliance>
```

In another embodiment of the present invention, the ova.xml utilized can be stored in a tar or a zip:

```
<?xml version=“1” ?>
<!DOCTYPE appliance PUBLIC “-//OVA//DTD OVA 1//EN”
            “http://www.openvirtualappliance.org/schema/ova-1.dtd”>
<appliance xmlns=‘http://www.openvirtualappliance.org/schema’
            version=“1”>
  <name xml:lang=“en”>
    <label>eSpiel Sales Solution</label>
    <shortdesc>eSpiel Sales Solution</shortdesc>
    <longdesc xml:lang=“en”>
eSpiel Sales Solution: A CRM, database and webserver packaged
solution.  http://www.espiel-sales.com/
    </longdesc>
    <detail>
Copyright &copy; 2006-2007 eSpiel Sales Solution Inc.
...
    </detail>
  </name>
  <version> 2.1</version>
  <vm name=“crm”>
    <name xml:lang=“en”>
      <label>eSpiel CRM</label>
      <shortdesc>eSpiel Sales Solution CRM</shortdesc>
      <longdesc xml:lang=“en”>
eSpiel Sales Solution CRM, running on Debian 3.1, packaged and
tested by eSpiel. http://www.espiel-sales.com/
      </longdesc>
      <detail>
Copyright &copy; 2006-2007 eSpiel Sales Solution Inc.
Debian 3.1r2, Mon 17 Apr, 2006.
...
      </detail>
    </name>
    <memory static_min=“64 MiB”>
    <vbd name=“crm-root-vbd” vdi=“crm-root” mode=“RW” />
    <vbd name=“crm-backup-vbd” vdi=“backup” mode=“RW” />
  </vm>
  <vm name=“mysql”>
    <name xml:lang=“en”>
    <label>eSpiel MySQL</label>
    ...
    </name>
    <memory static_min+“100 MB” />
    <vbd name=“mysql-vbd” vdi=“mysql-C” mode=“RW” />
  </vm>
  <vm>
    <vm name=“apache”>
    <name xml:lang=“en”>
    <label>eSpiel Apache</label>
    ...
    </name>
    <memory static_min=“32 MiB” static_max=“2 GiB” />
```

| | | |
|---|---|---|
| <vbd name=“apache-root-vbd” | vdi=“apache-root” | mode=“RO” /> |
| <vbd name=“apache-backup-vbd” | vdi=“backup” | mode=“RW” /> |
| <vbd name=“apache-webspace-vbd” | vdi=“apache-webspace” | mode=“RW” /> |
| <vdb name=“apache-cache-vbd” | vdi=“apache-cache” | mode=“RW” /> |

```
  >/vm>
    <vdi name=“crm-root” src=“file:///crm.qcow” variety=“system”
        chunksize=“1 GB” compression=“bzip2”>
    <name>
      <label>eSpiel CRM Root filesystem</label>
      ...
    </name>
  </vdi>
  <vdi name=“mysql-C” src=“file:///mysql.vhd” variety=“system”>
    <name>
    ...
    </name>
  </vdi>
  <vdi name=“apache-root” src=“file:///apache.vmdk” varitey=“system”
chuksize=“1 GiB”>
    <name>
    ...
    </name>
  </vdi>
  <vdi name=“backup” variety=“user” size=“10MiB”>
    <name>
    ...
    </name>
  </vdi>
  <vdi name=“apache-cache” variety=“ephemeral” size=“prompt:apache-
cache-prompt”>
    <name>
      ...
    </name>
  </vdi>
  <prompts>
    <prompt name=“ntp-server” type=“address” default=“pool.ntp.org”
phase “install”>
      <name xml:lang=“en”>
      <label>NTP server</label>
      <shortdesc>
Please specify the address for your NTP server, or use
pool.ntp.org if you do not have an NTP server
locally.
      </shortdesc>
      ...
      </name>
    </prompt>
    <prompt name=“apache-cache-prompt” type=“vdi” min=“10 MB”
default=“500 MB”>
      <name xml:lang=“en”>
      <label>Apache-cache</label>
      <shortdesc>Apache webcache</shortdesc>
      </name>
    </prompt>
    <prompt name=“admin-password” type=“password-twice” phase=“install”>
      <name xml:lang=“en”>
      <label>Administration Password</label>
      <shortdesc>
Please enter a password to use for the eSpiel Sales Solution
Administrator Console.
      </shortdesc>
      ...
      </name>
    </prompt>
  </prompts>
  <admin vm=“crm” port=“8088” path=“/” />
</appliance>
```

While the syntax utilized in the above described xml files may be utilized on any OVA, it is understood that those skilled in the art may created other xml files utilizing the Document Type Definition (DTD) provided below and the basic format of the OVA to package virtual appliances.

In one embodiment of the present invention the specification of a particular OVA may be encoded in the UTF-8 or UTF-16 formats as XML requires processors to process documents in those formats. An ova.xml file encoded using UTF-16 begins with the Byte Order Mark, as preferred by [XML]. The ova.xml file may begin with the Byte Order Mark if encoded using UTF-8. These two formats provide flexibility in determining whether an embedded encoding declaration is necessary.

By way of further exemplary description of a preferred embodiment of the present invention, the elements identified above in the exemplary ova.xml specifications are defined. The <vm>, <vbd>, <vdi>, and <prompt> elements each have a name attribute (indicated by % NAMEID in the DTD as shown below). The name attribute specifies a value that may be used to refer to that entity or element during installation. In some embodiments of the present invention, the name may not be repeated within the OVA, it may be case sensitive, and may include only the ASCII alphanumeric, minus and underscore characters. VMs, VBDs, VDIs, and prompts are in the same namespace; therefore, a VM may not have the same name as a VDI, for example.

An exemplary DTD for the ova.xml is given below. This DTD includes the entity declarations from [XHTML], for ease of use, and a few other entity declarations:

```
<!ENTITY % HTMLlat1 PUBLIC
  “-//W3C//ENTITIES Latin 1 for XHTML//EN”
  “http://www.w3.org/TR/xhtml1/DTD/xhtml-lat1.ent”>
%HTMLlat1;
<!ENTITY % HTMLsymbol PUBLIC
  “-//W3C//ENTITIES Symbols for XHTML//EN”
  “http://www.w3.org/TR/xhtml1/DTD/xhtml-symbol.ent”>
%HTMLsymbol;
<!ENTITY % HTMLspecial PUBLIC
  “-//W3C//ENTITIES Special for XHTML//EN”
  “http://www.w3.org/TR/xhtml1/DTD/xhtml-special.ent”>
%HTMLspecial;
<!-- a Uniform Resource Identifier, see [RFC2396] -->
<!ENTITY % URI “CDATA”>
<!-- a language code, as per [RFC3066] -->
<!ENTITY % LanguageCode “NMTOKEN”>
<!ENTITY % NAMEID “name NMTOKEN #REQUIRED”>
<!-- a filename, relative to the OVA root, using Unix-style paths -->
<!ENTITY % File “CDATA”>
<!ENTITY % LANG “xml:lang %LanguageCode; #IMPLIED”>
```

| | |
|---|---|
| <!ELEMENT appliance | (name, |
| | version, |
| | vm*, |
| | vdi*, |
| | prompts?, |
| | admin)> |

<!ATTLIST appliance xmlns %URI;

#FIXED

‘http://www.openvirtualappliance.org/schema’

version CDATA #REQUIRED>

| | |
|---|---|
| >!ELEMENT version | (#PCDATA)> |
| <!ELEMENT vm | (name, |
| | memory, |
| | vbd*)> |

<!ATTLIST vm %NAMEID;>

| | |
|---|---|
| <!ELEMENT memory | EMPTY> |
| <!ATTLIST memory | static_min CDATA #IMPLIED |
| | static_max CDATA #IMPLIED> |

| | |
|---|---|
| <!ELEMENT vbd | EMPTY> |
| <!ATTLIST vbd | %NAMEID; |
| | mode (RO \| RW) #REQUIRED |
| | vdi CDATA #REQUIRED> |
| <!ELEMENT vdi | (name)> |
| <!ATTLIST vdi | %NAMEID; |
| | src %URI; #IMPLIED |
| | variety (system \| user \| ephemeral) #IMPLIED |
| | compression (identity \| gzip \| bzip2) #IMPLIED |
| | size CDATA #IMPLIED |
| | chunksize CDATA #IMPLIED> |

<!ELEMENT prompts (prompt*)>
<!ELEMENT prompt (name)>

| | |
|---|---|
| <!ATTLIST prompt | %NAMEID; |
| | type (bool \| int \| string \| password \| password-twice \| |
| | address \| uri \| vdi) #REQUIRED |
| | default CDATA #IMPLIED |
| | min CDATA #IMPLIED |
| | max CDATA #IMPLIED |
| | phase (install \| upgrade) #IMPLIED> |

<!ELEMENT admin EMPTY>
<!ATTLIST admin vm CDATA #REQUIRED

port CDATA #REQUIRED
path CDATA #REQUIRED>

| | |
|---|---|
| <!ELEMENT name | (label, |
| | shortdesc, |
| | longdesc, |
| | detail)> |

<!ATTLIST name %LANG;>
<!ELEMENT label (#PCDATA)>
<!ELEMENT shortdesc (#PCDATA)>
<!ELEMENT longdesc (#PCDATA)>
<!ELEMENT detail (#PCDATA)>

The <appliance>, <vm>, <vdi>, and <prompt> elements may include nested <name> elements, which in turn may include <label>, <shortdesc>, <longdesc>, and <detail>. These elements may be in free-form text and may encapsulate values for the end-user's benefit, and are expected to be presented by the User Interface (UI).

The <name> element may have an xml:lang attribute, indicating the language in which the name is written. Multiple <name> elements may be present, each having a specific language. The language attribute may take one of the values specified by standard language identifiers such as those provided in [RFC3066]. A <name> element may include other attributes based upon the user's language and its availability. In cases where the language is not specified, the program may utilize a standard language, which in Western markets, for example, may be English. The number of labeled elements in each context may vary and may include and unlabeled element. Marking an elements with an xml:lang=“ ” is equivalent to omitting the value altogether.

<appliance> This field provides information about the type of OVA (i.e., the OVA specification being utilized to build the OVA) being utilized. The version number corresponds to the type of OVA being utilized with at that specific time following the major.minor scheme. The number may be assigned by the developers of the OVA format. For example, the current OVA is defined as version 1.0. As the OVA is updated, other versions are contemplated by the current invention. An OVA installer that supports version 1.0 may install appliances that declare version 1.x, for any x, but may limit installation of an appliance. For instance, the 1.x version may be maintained or updated separately from a 2.x version or above. Alternatively, the version of the OVAs may allow updating to any other versions.

<version> The version number here is the version of the virtual appliance encompassed by the OVA in a particular embodiment. The number may be assigned by the vendor or software developer that is utilizing the OVA as a transport mechanism for its particular appliance. The list may include decimal numbers, separated by full stops (periods). The list itself may be of any length from 1 to 10. Virtual appliance authors may organize version schemes to best fit the authors' needs. The version number may be compared utilizing the normal version number ordering system, as described above.

<label>, <shortdesc>, <longdesc>, <detail> The label, shortdesc, longdesc, and detail elements and may be presented by the UI as appropriate. The detail element may include any copyright, license, distribution details, and the version details allowing the end-user to check whether the virtual appliance is vulnerable to any known security holes. It is contemplated that vulnerability may be automatically checked. In one embodiment of the present invention vulnerability may be manually checked and parsing of fields is accomplished in ways alternative to machine-parsing. The <detail> field may allow the user to compare their application versions with CERT advisories, Microsoft® (Microsoft Corp. Washington, U.S.) security bulletins and other security information available for their specific applications. This allows the end-user to check for vulnerability regardless of whether they contact the appliance developer. In other embodiments of the present invention inclusion of the <detail> field may be optional.

During upgrade(s) of the OVA, the <appliance><name><label> values of the new OVA may be compared with the OVA used previously. If the values do not match, the user may receive a warning and may be asked to confirm that these are indeed compatible virtual appliances. Different labels for each product reduce the likelihood of encountering this type of problem. Virtual appliance developers that do not use ephemeral values, such as version number or year of release, may also reduce the possibility of facing this type of issue.

<memory> The memory element may include one or both of two optional attributes: static_min and static_max. These define the acceptable memory range for the VM that includes one or both attributes. The end-user may tune their systems within these values, or the VMM may tune the VM's memory between these values on the user's behalf.

Memory and disk storage sizes may be specified at various places within the ova.xml file. The value may be specified as a string, taking the form of a decimal integer or real number, optionally followed by whitespace, and then optionally followed by a units indicator, which may be one of the entries in the following table:

| Units Indicator | Value | |
|---|---|---|
| B | 1 | byte |
| kB | 1,000 | bytes |
| KiB | 1,024 | bytes |
| MB | 1,000,000 | bytes |
| MiB | 1,048,576 | bytes |
| GB | 1,000,000,000 | bytes |
| GiB | 1,073,741,824 | bytes |

Other designations can be utilize including T, P, and E up to 10¹⁸ and 2⁶⁰

The value given in the ova.xml may be multiplied by the units and rounded down. If the unit is omitted the number is understood to be in bytes. The following are examples of valid storage sizes: 6 MB (6 million bytes), 1.2 GiB (1,288,490,188 bytes), 612345 (612,345 bytes). In some preferred embodiments, the maximum value may be set to a specific value such as 2⁶⁴. This value may reflect user created boundaries or hardware limitations. The OVA is rejected at installation if any of the storage values exceeds the preset maximum. For example, if the maximum value is 2⁶⁴, specifying a value greater than 2⁶⁴ may result in an error that prevents the OVA from being installed. In one embodiment of the present invention the values are parsed during installation. When storage sizes are passed to the appliance during post-install or post-upgrade processes, the value is given in bytes.

<vbd> is a specification of a virtual block device (VBD) for the VM. The VBD utilizes a particular named filesystem (fs) or Virtual Disk Image (VDI) as described below. The vbd specifies the particular VDI or filesystem exported to the VM and the mode under which this occurs. This attribute may take a form similar to “sda1” for Linux-based VMs, and to “C:” for Windows® (Microsoft Corporation, Redmon Wash.)-based ones. The mode attribute may be either “r” or “w” (in some embodiments the attribute may be “RO” or “RW”), indicating that the device may be exported to the guest in read-only or read-write mode respectively. VBD ordering is significant, as the devices available to the VM appear in that specific order and the first VBD is the one from which the VM boots.

A single VDI or fs may be referenced by multiple VBDs. In the example above, the “backup” VDI was utilized by both the CRM VBD and the Apache VBD. As long as the access is read-only, this is safe with all non-ephemeral VDIs. If any of the VMs use that VDI in read-write mode, the filesystem included therein may be designed for that type of use, such as OCFS2, and/or the VMs in the virtual appliance may be configured to use a distributed lock manager. Sharing of ephemeral VDIs may be limited.

<fs> A specification of a filesystem or VDI. This filesystem is written to a storage substrate that may be exported to the VMs as specified by the per-VM <vbd> entries. The name attribute is of the same form as specified for the <vm> element, above. It is used by <vbd> elements for reference, and used to construct certain paths during installation, as detailed later. Each filesystem may have a different name.

The variety attribute provides guidance to the VMM and associated management tools as to how the disks associated with an appliance are to be treated. There are three varieties of VDI or fs. (1) System disks contain appliance software and may be completely replaced in the event of an upgrade. They can be populated from known sources on install. (2) User disks contain user data (for instance saved documents) that may be preserved across upgrades. The size of the disks may be specified by the user during the installation process. They may be populated with an empty file system during post-installation. Upon uninstalling an appliance, the user may be given the option of preserving user disks rather than deleting them. (3) Ephemeral disks contain temporary data that may be discarded when the VM shuts down. The VMM is free to allocate these disks on arbitrary storage and may delete them at VM shutdown. The VM may write a filesystem on ephemeral VDIs on every boot.

The source for the filesystem or VDI is specified by the Uniform Resource Identifier (URI) given by the source attribute. If this is a file: URI, then this is relative to the OVA root and it means that the VDI is included within the OVA package. Alternatively, it may specify a network resource including HTTP and HTTPS, in which case the VDI may be retrieved from the specified address. Each source may be packaged using a virtual disk format such as QEMU's QCOW, VMware's Virtual Machine Disk Format (VMDK), Microsoft's Virtual Hard Disk format (VHD), or other formats utilized by different VMMs. With any of those disk formats, the blocks may be copied directly to the storage substrate, because fs size may be taken from the size of the source. The use of one disk format, such as the virtual disk formats above, for disk transport may be different than the format used for storing the disk at runtime. The VMM may decide which runtime disk formats to use.

In another embodiment of the present invention, the source may be a tar file (optionally compressed). In this preferred embodiment, the filesystem type and size is specified. The filesystem may be created at install time, and then populated from the given tar. In this case, the filesystem may be on the Supported Filesystem List (which is not necessary when using virtual disk formats). If the source is missing and the filesystem type and size are present, then an empty filesystem may be created provided that the installer understands the filesystem. If the source and the filesystem type are missing, but the size is present, then an unformatted block device may be provided and the VM itself may format the block device appropriately.

In another alternative embodiment of the present invention, a simple raw file may be utilized and the block device size may be specified using the size attribute. Disk size may be determined from the source. In yet another embodiment, rather than a file:, http:, or https: URI, the source may take the form “prompt:name”, where name is declared later using <prompt name=“name” type=“uri”>. In this case, the source may be specified by the end-user, but otherwise it may be treated as previously explained. The final alternative for the source attribute is for it to be omitted. In this case, the disk is created, and the first megabyte may be zeroed so that the empty disk may be detected. The disk may then be populated by the virtual appliance itself during the post-install phase.

In one embodiment of the present invention, the size attribute may be given if the source attribute is omitted. The size attribute may also be utilized in other situations if desired. The size attribute may also take the form “prompt:name”, where name is declared later using <prompt name=“name” type=“vdi”>. In this case, the end-user may be prompted for the storage size and location.

Each VDI source may be compressed using either gzip [RFC1952], [bzip2] or other compression tools. The compression may be indicated using compression=“gzip” or compression=“bzip2” respectively. Alternatively, if the VDI source is an HTTP or HTTPS URI, or a prompt to which the user gives one, then the compression may be specified by the HTTP server, using the HTTP header Content-Encoding: gzip or Content-Encoding: x-bzip2 as described in [RFC2616]. The source may be transferred to the install destination in its compressed form and decompressed as it is written to the new virtual disk. Identifying whether compression is used may be determined by the compression attribute or specifying it as “identity”.

In a preferred embodiment of the present invention the disk image may be placed in one large file. In other embodiments, the disk image may be split into chunks. Splitting disk images into chunks provides that the appliance development and deployment may avoid being hindered by the restrictions created due to the filesystem's file size restrictions.

Chunking may be indicated by the presence of the chunksize attribute on the <vdi>; this attribute specifies the size of each chunk (except the last, which may be smaller). With chunksize specified, the source is treated as URI prefix. Each chunk may be loaded from source.NNNNNNNNN, where source is the value given for the source attribute, and NNNNNNNNN is the chunk number, starting from 0, and 0-padded to 9 digits. Each chunk may be extracted from the OVA, or downloaded by the OVA installer running on the destination, and the source may be assembled there.

When chunking is combined with compression, each chunk may be compressed individually and each chunk may be an equal slice of the uncompressed source. In the example, the crm-root VDI may be stored as crm.qcow.000000000, a bzipped file, which when uncompressed includes bytes 0 to 999,999,999 of a QCOW file. crm.qcow.000000001 when decompressed contains bytes 1,000,000 to 1,999,999,999, this progression may continue until the final chunk.

In one embodiment of the present invention, the OVA includes a security feature that allows the end-user to verify the validity of the OVA. This security feature allows the end-user to ensure that the OVA being installed comes from a trusted source. The security feature may include a manifest.txt, a signature.asc, a mf-signature.asc, or any other security file understood by one skilled in the art. The manifest.txt may contain a list of every file in the OVA and each file's SHA1 hash. The signature files may include information to verify the security of the OVA and its related components.

<manifest> The manifest element specifies a file (manifest.txt) that includes a list of entries, which may be configured as one entry per line, providing for each file in the OVA the SHA1 hash of that file, followed by the filename itself, separated by whitespace. (This is the output format used by the sha1 sum tool.) Other output formats are contemplated by the present invention. In one embodiment of the present invention, the manifest.txt, signature.asc, and mf-signature.asc files are excluded from the manifest.txt list, all other files—including ova.xml—are listed in the manifest.txt file. Integrity of each file in the OVA is checked against the given SHA1 hash. The virtual appliance and in the OVA may be prevented from running if the integrity check fails. Files not listed in the manifest may not be copied onto the VMM.

<signature> <mf-signature> The signature and mf-signature elements specify one file each giving a cryptographic signature for the ova.xml file and the manifest file respectively. In a preferred embodiment, the signature may be an OpenPGP-compliant signature, ASCII armoured, or an X.509 certificate packaged using PKCS #7 [RFC2315]. Other signature and encryption techniques may be employed. Use of detached signatures makes it easy for tools to validate them separate from, and prior to, the installation.

During installation, the validity of the two signatures is checked. The end-user may be prompted for authorization, when the chain of trust for the signatures cannot be established. In that case, the end-user may be allowed to make the trust decision. If the validity check fails or the chain of trust cannot be established and the user does not validate the signatures, installation may be aborted.

It is contemplated that in order to validate the signatures, the wwwkeys.pgp.net (or one of its mirrors) for the key used in the signature is checked to ensure the key has not been revoked. If the key has been revoked, installation may be aborted. An OVA author may upload their key to wwwkeys.pgp.net, or a similar key location, if they distribute their OVA. Uploading the key onto an available location, allows the end-user to determine whether that key has been revoked.

If it is not possible to check the key at its network location (e.g., wwwkeys.pgp.net), because the destination host is not connected to the network, a chain of trust cannot be established, or a key has expired or been revoked, then end-user is informed of that fact and allowed to either continue or abort the installation. All or part of the information in the signature may be provided and the end-users may be allowed to make the trust decision themselves. If a signature is demonstrably invalid (the key is available, but the signature does not match) the user may also be prompted. In this later case, a stronger warning may be presented to the user. If the user does not trust the certificate, the installation may be aborted.

The signature verification process allows the end-user to check the signature and the validity of the signing key. In some embodiments of the present invention the user is not required to check the signatures and he or she may ignore any failure in the establishment of trust or expiration or revocation of signature keys. Signature warnings should be unusual events worthy of attention, not an ordinary dialog to be clicked through automatically.

Another embodiment of the present invention allows OVA developers who use OpenPGP-style keys and who distribute their OVAs to place the signing keys on a public server. This may ensure that the end-user may, if they so wish, validate their appliance against a publicly available key. By making this process part of the normal install flow and, ordinarily transparent to the user, allows for higher confidence on the OVA. In one embodiment of the present invention, the key delivery can be included in the OVA itself. The OVA installer is able to establish a chain of trust for that key. Using this option limits the ability of the OVA creator to revoke keys.

<config> This file attribute gives the configuration file for the VM that may be given to the VMM when the domain is started.

<properties> Each property may be declared by name, which may be different across properties, and declared to have a particular source. The source may either be of the form “prompt:<name>” or “script:<name>”, declaring that the value is obtained by prompting the user at install-time, or by running a script. In either case, the name given is a reference to an <prompt> or <script>, declared separately.

<prompts> The prompts section gives a simple specification for prompts that may be given to users in order to receive install-time parameters. Through this mechanism, developers may allow the end-user to customize their virtual appliance. The answers given by the user may either guide the creation of VDIs, or be retrieved by the virtual appliance during post-installation or post-upgrade.

The name attribute is used to label the prompt, as for the <vm> element, and the contained <name> element may be used to give the question and associated guidance and documentation. Each prompt may be annotated with phase=“install” or phase=“upgrade”. When this option is used, the question is only asked during the appropriate phase. Omitting the phase declaration implies that the question may be asked during all maintenance phases. Answers to the phase=“install” may be recorded by the platform and may also be available to the virtual appliance during upgrade. It is contemplated that these questions may be asked again during or at certain events, such as upgrade and uninstall. When the question is not asked, the original answer is utilized by the virtual appliance. Additionally, a prompt may have an specified default.

Each prompt may be of a compulsory type (e.g., bool, int, string, password, password-twice, address, uri, vdi, and other types recognized by person of ordinary skill in the art). For example, a prompt marked “bool” accepts yes/no answers, “int” includes an integer value, and those marked “string” accept free-form text. Some prompts may allow for additional restriction attributes. Integer prompts, for example, may be constrained using the optional attributes min and max. If either min or max is omitted, the value is unconstrained in the direction of the missing attribute.

Password prompts may be the same as strings, but the valued may not be echoed to the screen when prompting. Prompts of the “password-twice” type ask for the password to be typed twice and acceptance of the value occurs if it is the same on both occasions. “password” is suitable for prompting for existing passwords and “password-twice” is suitable for new passwords.

Prompts with the prompt type=“address” may be restricted to be a valid DNS name or IP address. Those with type=“uri” include a valid HTTP or HTTPS URI. If a prompt is marked “vdi”, then the user selects a new storage location and size, using the platform's normal mechanisms for storage selection. In this case, the min, max and default attributes may be present, indicating minimum, maximum and default disk sizes. If either min or max is omitted, then the disk size is unconstrained in the direction of the unconstrained or omitted attribute.

<prompt-values> Prompt values may also be ‘late-bound’, i.e. specified by the end-user or a third party to create a new OVA. This allows them to specialize or partially specialize an OVA for their particular cluster, for example. These overriding values may be separated out so that the history of OVA modification is clear. In the first example, the prompt-value line specifies that the property “ntp-server” has been set to have a value of “ntp.intra” and that this value is only a default (fixed=“no”). The normal prompt for that value may still take place, but including a default of the given value. With fixed=“yes” is used appearance of the prompt may vary.

<scripts> Scripts may be declared in the <scripts> section. The script itselfis named, relative to the root of the OVA, and may be executed in the environment discussed in a later section. The param elements specify the command line parameters for the script, and may include property expansions, as shown in the example. The script exits with 0 for success, as usual, and print <name>=<value> pairs for each of the properties that it defines.

Given that OVA properties may be defined as the result of script execution, and scripts may take property expansions, there may be an implicit script execution order, which may be discovered at install-time. If there is any cycle in the dependencies, then the install may be rejected. These scripts may be executed in the order that they appear in the <scripts> section. The ordering between any two scripts may be constrained by property dependencies as described above.

<aux-file> The aux-file element names a file, relative to the root of the OVA. This file may be made available within the scripts' execution environment. Any number of aux-files may be named. Files referenced by the <script> element may not be named.

<hooks> Scripts may be run automatically during install and uninstall. These may be specified as hooks on certain events, and reference named scripts declared in the <scripts> section. The events may be “pre-install”, “post-install”, “pre-uninstall”, “post-uninstall”.

<admin> The admin element specifies a VM by name, a protocol (one of “http” or “https”), a TCP port and path. These four attributes, given the address of the virtual machine, are combined to give an HTTP URL. At this URL, there may be a web interface that may be used to administer the virtual appliance. The web interface may be designed to a full-featured web browser with availability to HTML4, CSS1, cookies, redirects, and other features expected to be found in modern desktop web browsers.

In a preferred embodiment of the present invention, each of the scripts specified in the <scripts> section may be executed in a tightly controlled environment. A guest domain may be created, with a standard Linux-style (LSB) directory layout. The Perl interpreter may be present. There may be a variable in the script's environment named OVA_SESSION. This variable may give a session key pre-authenticated for use as the virtual appliance is installed. Every file named using an aux-file element may be available under /var/lib/ova/aux-files.

The block devices for the VMs may be available as /var/lib/ova/vm/<VM name>/<device name>, where <VM name> may have the value specified using the <vm> element's name attribute, and <device name> may have the value specified as the device attribute of the <vbd> element (with the colon removed, if any). For example, the root device for the eSpiel CRM virtual machine may be at /var/lib/ova/vm/crm/sda1, and for the database server may be at /var/lib/ova/vm/mysq1/C. These may be block device special files, or symbolic links to them, and may be written through. The filesystem specified using the <fs> element may already be in place, unless this script is running off a pre-install or post-uninstall hook. Filesystems may also be available through /var/lib/ova/fs/<name>, where name may be the attribute given on the <fs> element.

It is contemplated that the VM's new filesystems may be mounted within the installation guest if the filesystem thereon is in the Supported Filesystem List provided below. The /tmp, /mnt, /var/lock, and /var/log directories of the script's guest domain may be writable; all other directories may be read-only. The writable directories may be used by the scripts to communicate values from one to another. For example, one script may place a cache of auto-detected values that may be used by later scripts to avoid repeating the detection process.

In a preferred embodiment of the present invention, the script may be run with stdout redirected to an unspecified file; the installer may use the script output to set new property values. The script's stderr may be redirected to /var/log/ova/<VM name>/<script name>. stdin may be /dev/null. The contents of /var/log may be collected after the installation and saved. The filesystem backing the writable directories may then be discarded.

A script may be terminated at any time, on the instruction of the user, by shutting down and then destroying the guest and aborting installation. If an OVA script is expected to take an unusual length of time to execute, that may be mentioned in the accompanying documentation. This approach has the benefit of providing a strongly isolated but highly flexible means for OVAs to customize appliances as they are installed. It is contemplated that a Linux-based execution environment with support for scripting languages may be applicable even for the customization of non-Linux VMs as such environments are very lightweight. Alternate scripting environments (e.g. Windows® (Microsoft Corporation, Redmon Wash.)) may also be utilized.

In one embodiment of the present invention, the first time a VM is run, sometime after installation, the OVA installer may place entries into a VMM's control channel (e.g., the Xen store) detailing the properties obtained or calculated during the install. This allows the guest to act upon those answers to complete the installation. A single entry /local/domain/<domid>/ova=<path to OVA section> may be written. The guest may be able to reference this using the relative path “ova” without needing to know its own domain ID. Using that path as a prefix, the directory “properties” may be found, and each of the key-value pairs given for each of the OVA's properties may be found inside that directory.

In the first example, the domain may set its NTP server configuration by using the following code:

ovapath=$(xenstore-read ova)
server=$(xenstore-read “$ovapath/properties/ntp-server”)

Note that in this example, XenStore is simply being used to provide a mechanism to access a hierarchical XML install-time data structure. Comparable mechanisms may be provided using the established control channels available on other popular VMMs such as VMware and Virtual Server.

In another embodiment of the present invention, as shown in the second example, the virtual machines may be started after the root filesystems specified within the ova.xml file have been created. Each VM may run in “fully virtualized” mode, and boot from its first VBD. This applies to the first boot after installation and upgrade. The VMs may then populate any disks left unpopulated by the installations (i.e., those with source unspecified). New disks may have the first megabyte zeroed and may be detected as blank. On upgrade, unformatted user disks may be populated with data.

During the maintenance phase (post-installation and post-upgrade), each virtual machine may be able to access an XML-RPC server on the VMM, on IP address 169.254.255.254, TCP port 6821 (OVA1) or other designated address, on any of the VM's virtual network interfaces. This communication may be intercepted by the VMM. This server provides a number of XML-RPC requests allowing the VM to determine the environment in which it is installed. In addition, it allows the appliance to select from available platform-specific options. The VM is able to also retrieve the answers given by the end-user to the questions asked prior to installation. The RPC may send information back to the OVA installer for progress display, logging and other functions.

In one embodiment of the present invention, [XMLRPC] over HTTP 1.1 [RFC2626] over TCP/IP may be the protocol used. Each standard RPC method name may begin with “OVA”. The platform identification RPCs may be documented in terms of the expected result. Platform vendors may use other strings to accomplish the same result. The following table provides some examples of the strings that may be used and their meanings

| XML-RPC Request | Meaning |
|---|---|
| OVA.get_platform | Returns a string identifying the VMM |
| OVA.get_platform_version | Returns a string giving the version of the |
| | VMM. For example, on Xen this may be |
| | “Xen X.Y.ZN” where X, Y, Z may be the |
| | release of Xen (e.g. 3.0.3). N may be |
| | optional information, such as “−1” or “unstable” |
| OVA.get_platform_manufacturer | Returns a string giving the manufacturer of |
| | the VMM. For example, platforms |
| | released as XenSource products return |
| | “XenSource Inc.” If they are compiled |
| | from unmodified sources taken from the |
| | Xen project website, the return may be “xenbits”. |
| OVA.get_phase | Returns “install” or “upgrade” |
| OVA.get_prompt_value | An RPC request “OVA.get_prompt_value |
| | (prompt name)” may return the answer |
| | given by the end-user to the specified |
| | prompt. If the prompt had type string, |
| | password, password-twice, address, or |
| | URI, the entered text will be returned. |
| | Boolean prompts may be returned as “yes” or “no”. |
| | Integers may be returned as the decimal |
| | representation in text. A request for the |
| | value of a prompt with type = ”vdi” may |
| | return the decimal representation of the size |
| | of the created VDI, in bytes. Note that the |
| | XML-RPC types are not used here - this |
| | means that the result of this call always the same |
| | type (string). |
| | Note that answers given to prompts during |
| | installation may be saved by the platform, |
| | and may also be avialable during upgrade. |
| | Requesting the value of a prompt that does |
| | not exist is an error, and may terminate the installation. |
| OVA.get_language | Get the language code selected by the OVA |
| | installer as the one most appropriate for the |
| | user. This may be one of the codes used to |
| | label the <appliance><name> elements in |
| | the appliance's ova.xml, or the empty |
| | string if the unlabelled element has been selected. |
| OVA.get_network_address | A VM may request the network address of |
| | any other VM in the appliance (including |
| | itself) using the XML-RPC request |
| | “OVA.get_network_address (VM name)”. |
| OVA.success | Once the VM has successfully completed |
| | its post-install or post-upgrade work, it may |
| | call OVA.success, to which it may receive |
| | an empty response. Once that response is |
| | received, the VM shuts down, and once all |
| | VMs have shut down, the phase is completed. |
| OVA.failed | If post-installation or post-upgrade fails for |
| | some reason, it may call OVA.failed |
| | (reason). In this case the whole process |
| | may fail, including terminating the other |
| | VMs in the appliance. The parameter may |
| | be a string that describes to the user the reason for |
| | the failure. |
| | Multilingual appliances may use |
| | OVA.get_language to guide |
| | internationalization of the error message. |
| OVA.progress | By calling OVA.progress(percentage, |
| | message), the VM may inform the user of |
| | the progress of the post-install or post- |
| | upgrade. This may be rendered by the |
| | OVA installer, and in particular is a useful |
| | diagnostic aid if the installation stalls. |
| | The percentage can be a double, giving the |
| | completion percentage of the phase, as far |
| | as that VM is concerned. |

In a preferred embodiment of the OVA of the present invention, each VM in an appliance will in general need to be able to contact each other. In order to achieve this, the user interface enforces the fact that every VM is attached to at least one network in common across the appliance.

If the VM is configured to take its address from DHCP, the DHCP server may be interrogated for the VM's fully qualified domain name, using the MAC address allocated to the VM's interface on the common network as the dhcp-client-identifier. If the VM is configured to have a static IP address on the common network, then that IP address may be used instead.

In one embodiment of the present invention, whether obtained from the DHCP server or directly from the VM's configuration, the address of each VM in the virtual appliance on the common network may be placed in a location accessible to the VM at boot time (e.g., the Xen store). The value is placed at $ovapath/vm/<VM name>/address. As described previously, comparable approaches are possible on other VMMs. Each VM may place a watch on these paths in the store, and pick up the new address when the VM's configuration is changed. Alternatively, the VMs may use Zeroconf or other rendezvous technology, or they may negotiate using shared storage with a cluster filesystem. In another preferred embodiment, each VM may contact any other VM in the appliance by requesting the correct address using the XML-RPC request “OVA.get_network_address (VM name).” Alternatively, the VM's may use Zeroconf or other rendezvous technology, or they may negotiate using shared storage with a cluster filesystem as described above.

In a preferred embodiment, the current invention provides an executable instruction set for a packaging format of a virtual machine. As has been described previously, the executable instruction set guides the management of the virtual machine throughout its life cycle. The executable instructions are provided in a manner appropriate for their execution upon an information handling system capable of processing digital information. It is contemplated that the executable instruction set of this embodiment is preferably implemented upon a computing/processing system for execution of the commands provided therein. The computing/processing system may be any various information handling system that is capable of performing the commands of the instruction set. In the current embodiment, the instruction set is implemented upon a computer, such as a server, PC, or other alternative computers, wherein the computer includes the capability of processing the digital information of the instruction set.

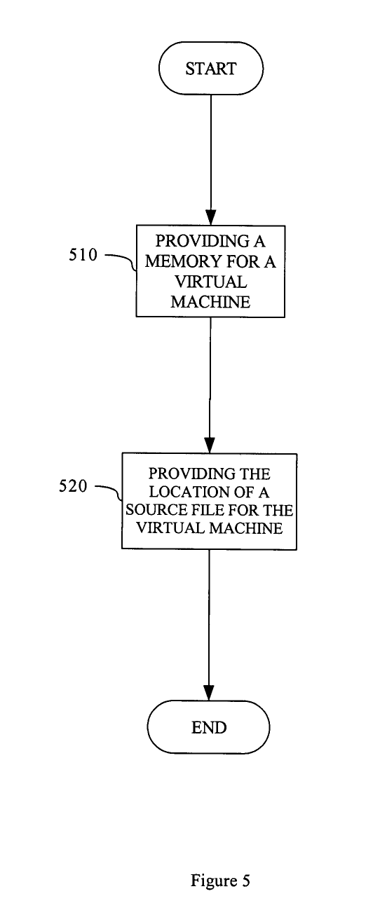

As shown on FIG. 5, a first instruction provides information regarding the memory requirements of the virtual machine 510. As shown above in the exemplary embodiments of the current invention, the memory may be identified as a specific integer factor of a particular memory size designation, as a maximum or minimum value, or as a range of memory capacity (e.g., from a minimum size to a maximum size). As indicated previously, the instruction of memory for the virtual machine may provide an initial threshold for instantiation of the virtual machine. For instance, where a virtual machine memory instructs a memory size that is greater than the memory capacity of the computer (processing/information handling system) upon which the virtual machine is to be instantiated, the virtual machine may have its instantiation aborted/terminated.

A second instruction provides information regarding the location of a source file for the virtual machine 520. As shown in the exemplary embodiments of the current invention, the source file location is indicated through the use of the current invention's novel formatting system which allows for the instantiation of a virtual machine within any virtual environment. For example, as described previously, a <vbd> provides an identifier that directs an executable process upon a computer, such as an installation process of a virtual machine, to be directed to a particular location which is a <vdi> or <fs>. Next, the <vdi> or <fs> provides an identifier that directs the process to a particular location which is a “file” location. This file location or “source” file is the location where the information required for performance of the process may be found. Thus, it is contemplated that the instruction set may include various other instructions, such as one or more instructions to read the <vbd> and or <vdi>/<fs> and proceed to the locations indicated by their designated identifiers.

In a preferred embodiment, a system for instantiating a virtual machine is provided. As described throughout the instant specification, the current invention allows a person of ordinary skill in the art to instantiate any virtual machine within any virtual environment. Thus, the current invention allows virtual machine and/or appliance users, manufacturers, producers, and others, to utilize all the various machines and/or appliances, regardless of their formatting, within any virtual environment, regardless of the formatting of the virtual monitor (hypervisor) by which the virtual machine/appliance is installed and allowed to execute.

The system includes at least one virtual machine. The virtual machine, as previously indicated, may be an operating system alone or may combine an operating system with one or more applications. The virtual machine includes a packaging format for the virtual machine having an executable instruction set, including virtual machine specific information, for guiding the management of the virtual machine throughout the virtual machine's life cycle. It is contemplated that the system may include a virtual appliance including two or more virtual machines. The packaging format is capable of including instructions within its instruction set which include specific information for each of the virtual machines within the appliance. Therefore, the packaging format is still capable of guiding the management of all of the virtual machines, included within the virtual appliance, throughout the life cycle of all of the virtual machines.

The system further includes a processing environment for executing the instruction set and instantiating the virtual machine within a virtual environment. In a preferred embodiment, the processing environment is a virtual environment. The virtual environment is established and controlled by the virtual monitor (hypervisor). Control over the processing that occurs within the virtual environment is found in the virtual monitor. Therefore, the processing environment is the virtual environment provided by the virtual monitor. Alternative processing environments for accomplishing the current invention may be used as may be contemplated by those of ordinary skill in the art.

It is further contemplated that the system include various other component features. For example, the system may include a network (e.g., Internet, intranet, LAN, WAN, and the like as known to those of skill in the art) that is communicatively coupled with the virtual machine and/or processing environment. The communicative coupling may occur through the use of various communication technologies as are well known to those skilled in the art. As described above, the system may include two or more virtual machines for performance of one or more particular computer programs. When, for example, the system includes two or more virtual machines packaged within a single packaging format in accordance with the principles of the current invention, execution by the processing environment may occur in a very similar manner as that described above. When, for example, the system includes two or more virtual machines packaged separately, then the processing environment may be presented with two or more packaging formats for execution of two or more instruction sets, in accordance with the principles of the current invention. Such execution may be achieved in any manner consistent with the operating principles and parameters of any virtual monitor (hypervisor)

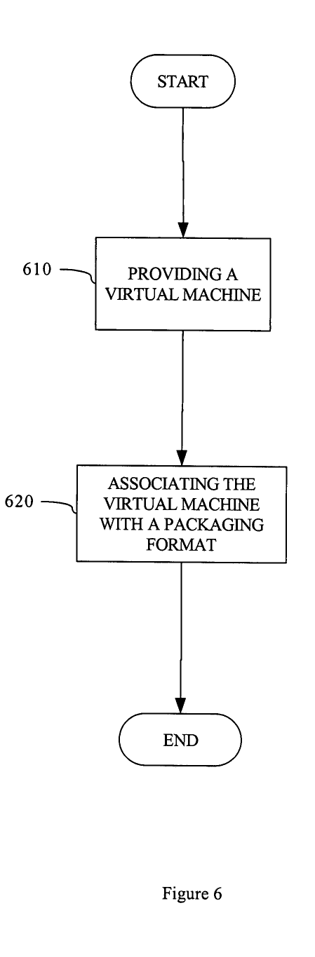

In another preferred embodiment, the current invention provides a method of formatting a virtual machine. The formatting provided by the current invention allows the instantiation of the virtual machine within any virtual environment in accordance with the principles of the current invention set forth throughout the instant specification. As shown in FIG. 6, in a first step of the method a virtual machine is provided 610. The virtual machine may be provided in various forms and formats as contemplated by those of skill in the art. It is also contemplated that the virtual machine may be more than one virtual machine bundled together in a virtual appliance, as previously described.

In a next step of the method, a packaging format, including virtual machine specific information, for guiding the management of the virtual machine throughout the virtual machine's life cycle, is associated with the virtual machine 620. The association of the packaging format may be accomplished in various manners and at various points in the construction of the virtual machine, as may be contemplated. For instance, the creator/manufacturer/producer of the virtual machine may incorporate the packaging format, in accordance with the principles of the current invention, into their virtual machine and provide it as a comprehensive package of information. In the alternative, the packaging format may be created separately from the creation of the virtual machine, but still using specific information from the virtual machine. Then, sometime after the creation of the virtual machine, the packaging format is associated with the virtual machine. The association of the packaging format with the virtual machine may occur within various computer processing environments (e.g., PC, server, and the like) and/or may occur over various networks of computers, as know by those skilled in the art.

From the above description it is to be understood that the method of formatting a virtual machine may include an additional step of creating/constructing the packaging format for association with the virtual machine. The exemplary embodiments provided throughout the instant specification provide examples for the creation/construction of a packaging format in accordance with the current invention. Wherein the specific information from the virtual machine is incorporated into the executable instruction set of the packaging format. Therefore, depending on the virtual machine(s) involved, the number of instructions provided may vary greatly.

Other steps in the creation/construction method may provide for the inclusion of various customization and/or security features within the packaging format. As described previously, the types of and manner in which the customization/security features may be included within the creation of the packaging format may vary.

Once the development stage is completed, the OVA is ready for installation. The OVA may be installed in the following sequence:
(1) The OVA is checked for integrity,
(2) The end-user is prompted for configuration parameters, including storage location for new virtual disks,
(3) One or more virtual machines is created. The filesystems (including root and optional additional filesystems) for each virtual machine are created by one of:
   (a) creating a filesystem based upon data inside the OVA itself;
   (b) downloading filesystem contents from some preconfigured location;
   (c) prompting the user for a filesystem location, and then downloading from there.
In any of the above cases, the filesystem may be created by a direct copy of data blocks, or by creating a filesystem and then populating it by copying files into the new filesystem.
(4) The end-user may have been prompted for the filesystem size, or for a parameter that indirectly determines the filesystem size. If the filesystem is to be populated by copying files, then the specified size may be honored when the filesystem is created. If the filesystem is populated by copying blocks, then the filesystem may be resized after creation as part of the install. The installer may fail the operation of the VM when the filesystem cannot be resized.
(5) Once installation is complete, one or more of the new virtual machines may be launched allowing a post-installation phase to begin. In this phase, the virtual appliance may customize itself based upon the parameters given by the end-user. Because this customization phase may be running within the virtual machine itself, the virtual appliance in effect may provide its own execution environment for the install, including a fixed and known context.
(6) During the post-installation phase, each VM may make requests to an XML-RPC server on a fixed address and port. These requests may be intercepted by the VMM, validated, and acted upon appropriately. They may provide notifications of progress or failure during post-installation, or reconfiguration requests. Through this mechanism, the virtual appliance may discover the platform on which it runs, allowing it to configure itself for best performance.

A user may upgrade a virtual appliance using a new version of an OVA. In such situations a similar procedure is followed:
(1) An integrity check may be performed, similar to the one conducted during the install phase,
(2) The end-user may be prompted for configuration details, although in this case, the questions may be entirely different, depending on the OVA's configuration,
(3) The old OVA may be started in a special “pre-upgrade” phase, allowing the appliance to make a backup of configuration details, or any other preparation,
(4) The upgraded filesystems for the appliance may be created in the same way they were created during the install phase. The user filesystems may be preserved, allowing user data to be carried across the upgrade.
(5) Each of the virtual machines may be launched using the new system filesystems, for the post-upgrade phase. In both the pre- and post-upgrade phases, the XML-RPC server and logging facility may be available in the same way they are available during install phase.

In one embodiment of the present invention, an OVA can be used to package a customer relationship management (CRM) solution. The virtual appliance may include three virtual machines: a CRM application, and support VMs containing an Apache web server, and a MySQL database. During deployment, the OVA may customize system details such as the address of the NTP server to use, and installs the virtual appliance onto the system.

It is contemplated that the OVA may be used in other applications. For instance, the OVA of the present invention may be effectively utilized in large-scale virtual appliance deployment. An OVA-based virtual appliance, through the use of various tools, may be configured and deployed concurrently into large numbers of virtual appliance instances. This may be of benefit in deploying new applications within a cluster or datacenter environment, and in deploying desktop software across an organization.

Another instance where the OVA of the present invention may provide benefit is in virtual appliance-based VM services. OVA-based virtual appliances may, in some cases, provide services for a VMM-based system that may be applied to other VMs or system resources. Examples of this sort of “platform service” include virtual appliances performing things such as backup, virus scanning, and network firewalling. Virtual appliances may include servers, such as web servers, FTP servers, DNS, WINS, DHCP, BOOTP, LDAP, and Active Directory servers, or storage servers such as NFS, or CIFS.

Another area where the OVA may be of benefit is assisting in the Physical-to-Virtual (P2V) conversion. A common requirement in the deployment of VMMs in non-virtualized environments is that of converting existing physical system images to VM-based images. As a transport format, OVA provides a clean separation between tools that convert a system image away from a system host, and the specific runtime representation used by each individual VMM. The OVA format allows P2V tools to package an existing non-virtualized system in a manner that the resulting image may be installed on any OVA-supporting VMM.

It is contemplated that the present invention may be beneficial for Desktop Migration. OVA may be used as a transport format for a virtual machine, when that VM is used as a particular user's desktop. This “desktop VM” may be transported as an OVA to and from a central server, or on a peer-to-peer basis, to allow the user to have their desktop move with them.

The user may use a machine with a VM already installed, or may carry a VM on a portable storage device. Then, on the destination machine, they may call up the OVA containing their desktop VM, and run it, or that OVA may have been sent in advance so that it was ready for when the user arrived at their destination.

It is further contemplated that the OVA of the present invention include various tools that may be useful in combination with the OVA. Such tools may include, for instance, tools for fetching and sending OVAs, to and from a remote server or peer, tools for finding OVAs, from a catalogue of appliances, creation/authoring tools, to aid the development of OVA-based virtual appliances, tools for creating OVAs through a physical-to-virtual (P2V) operation, and tools for creating “upgrade OVAs”—i.e. for applying a known set of changes to given OVA, and creating a new OVA from that. Still further, the OVA may include tools for exporting a virtual appliance as an OVA from a virtual machine, tools for installing OVAs so that a VMM may execute them, tools for cloning, modifying, and specializing an OVA to suit an end-user's particular site or deployment scenario, tools for the testing of OVAs, in particular automated test of install and upgrade of OVAs, and integration with other test suites, integration of any or all of the above tools into a unified application, and portability of any or all of the above tools, so that they may be installed upon portable storage and used on any machine. The type and number of tools that may be associated with OVA of the present invention may include any of the items listed above and other tools as contemplated by those of ordinary skill in the art. The tools listed above are not intended to be an exclusive list and should not be read as limiting the current invention.

During the maintenance phase, each virtual machine may be able to send log messages using the same contact details as for the XML-RPC server, but using a different port, such as port 6822 (OVA2), instead. Text sent to this port may be treated as UTF-8 encoded plain text, and displayed to the user on request. The platform may convert CR-LF pairs to CR or LF, or vice versa, but otherwise, the log messages may be unmodified. Many guests may be able to configure their standard logging service to use this port directly—syslog-ng may be able to log to a remote server in this manner, for example.

During post-installation, an appliance may interrogate the XML-RPC server to determine the platform on which it is executing. This gives the appliance the opportunity to install enlightened (paravirtual) kernels or drivers, as appropriate to that environment. This may greatly improve performance of the VM. Installation of enlightened drivers may be accomplished by detecting the platform on which the appliance is being installed, using the calls above, and select appropriate enlightened drivers.

Another embodiment of the present invention contemplates the installation of paravirtual kernels. A user may use these mechanisms when they are explicitly detected and available. The VM may continue to run in fully virtualized mode if these mechanisms are not available. Detecting these and other extensions may be based upon the OVA.get_platform( ) result. These mechanisms may be used when a platforms such as “Xen,” known to support these enlightenment extensions, is detected. It is contemplated that mechanisms additional to those available in “Xen” are within the scope of the present invention.

In one embodiment of the present invention an OVA may be run in Xen utilizing the following procedure. OVA.Xen.set_pv_boot_details(bootloader, entry, kernel, ramdisk, args) sets the boot details for the calling VM to the given values. Next time the VM boots, after post-install, the VM may run in paravirtual mode, using the specified details. If the bootloader is empty, the kernel and optional ramdisk may be taken from the OVA—these two fields may be URIs, meeting the same specification as for disk sources (an HTTP or HTTPS URL, a file URL, giving a path relative to the root of the OVA, or a reference to a URI prompt). Otherwise, the bootloader may be one of “pygrub” and “domUloader”, or other values as appropriate to the Xen release in question, or the applicable VMM being used. The entry, kernel, ramdisk, and args fields may be passed to that bootloader, for appropriate action to be taken. Using kernels external to the VM (i.e. bootloader is empty) may be recommended for appliances without root filesystem, or their root filesystem on a ramdisk. Keeping the kernel inside the VM may be preferable in some cases, because it may make it easier to keep kernel, modules, and userspace tools such as udev in sync. When booting in fully virtualized mode, the block devices for each VM may be available in the order that they are specified in the ova.xml. When OVA.Xen.set_pv_boot_details is called, these devices may be redeclared making them available to the enlightened kernel as xvda, xvdb, and others. The devices may be named appropriately to be compatible with most non-Linux kernels, (as provided in the OVA.Xen.set_vbd_frontend_device, for example).

During the post-upgrade phase, the VM may run in HVM mode, just as it may for post-install. Running in HVM mode may give the VM the opportunity to install an upgraded paravirtual kernel. If set_pv_boot_details is not called during the post-upgrade phase, then the VM may run in HVM mode permanently, even if a paravirtual kernel had been set in the past.

OVA.Xen.set_vbd_frontend_device(VBD name, device name) sets the front-end device name for the named VBD to the given name. This may take effect at the next boot. The device name may take a form similar to “xvda” or “sda” for Linux-based VMs, or an integer for OpenSolaris, for example.

Appliances may be upgraded in one of three ways. First, existing software packaging, installation, and upgrade tools may be used by the installed application to fetch upgrades from the network and install them from within the installed virtual appliance instance. Second, binary patches or hotfixes may be applied to installed virtual appliances. Third new, upgrade OVAs may be applied to installed virtual appliances.

In-VM upgrade tools such as application-specific upgrade managers, the Windows patch tools and Linux package managers such as yum, apt, Conary, RPM, or dpkg may be used to maintain the contents of an installed appliance. If enlightened kernels or drivers have been installed within the appliance, the packaging system may need to be made aware of their existence in order to upgrade the enlightened elements correctly. These tools may function as any other VM-contained application.

Binary patches and hotfixes may be provided by appliance vendors to allow updates to be applied to installed appliances externally. Packaging such updates externally allows a convenient vehicle to apply changes to large numbers of virtual machines, and is particularly useful in responding to security concerns in a timely fashion.

OVA upgrade patches allow an appliance to be upgraded through the application of a newer OVA version. Generally speaking, this upgrade reinstalls all system vbds, erases all ephemeral vbds, and preserves the contents of all user vbds. Any post-processing (e.g. file format conversion of user data) may be done in install scripts.

OVA allows a virtual appliance to be upgraded through the application of a newer version of the same virtual appliance. Generally speaking, this upgrade may reinstall all system VDIs, erase all ephemeral ones (as may happen on any reboot in any case), and preserve the contents of all user disks. Any post-processing (e.g. file format conversion of user data) may be accomplished in the post-upgrade phase. Virtual appliance authors may be given the option of selecting an upgrade facility. Large, complicated appliances with a lot of user interaction, such as a pre-packaged full Linux distribution, may wish to use a packaging system, and never use the full-disk upgrade mechanism. Taking this option allows the end-users to install their own packages inside the virtual appliance, over its lifetime. Alternatively, a virtual appliance with few user-configurable parts and stable software, such as a firewall, may prefer the whole-disk upgrade, which has the advantage that there is less to go wrong, less for the customer to break, and that it is very easy for the customer to return the appliance to a known state.

When a user initiates a whole-appliance upgrade, a new OVA may be passed to the tools, and specify an appliance to upgrade. The new OVA may be checked for integrity and signature validity, and then the name of the new OVA (<appliance><name><label> where <name> has no xml:lang attribute specified) may be compared with the name of the old OVA, checking that the two strings are equal. If they are not equal the user may be prompted to confirm whether the new appliance is in fact an upgrade of the old one.

The integrity check for upgrade may include compatibility between OVAs. It may be illegal for a VDI to be declared in the new OVA with the same name as one in the old OVA, but with a different variety. The end-user may be prompted for configuration details, using the <prompt> entries from the old OVA that are marked with phase=“pre-upgrade”, and those marked with phase=“post-upgrade” from the new OVA. If there is overlap between the old and the new OVA, that is, if a prompt with the same name appears in both the pre-upgrade and post-upgrade phases, this question may be asked only once, with the labeling taken from the new OVA. The user may also be prompted for storage locations and sizes, if unspecified by the OVA, of all of the new (system and ephemeral) disks.

Once the prompting is complete, the old virtual appliance may be shut down in its entirety. If specified in the old OVA, the old virtual machines may be started using the boot details marked “pre-upgrade”. The virtual appliance may run in this mode until every virtual machine has shut down. In this mode, the XML-RPC server and logging facility may be available, just as during the install phase. This phase allows the old appliance to clean up before upgrade.

Once every VM in the old virtual appliance has shut down, the system and ephemeral disks may be discarded. At the user's request, these disks may be deleted at this point (if there is not enough space for the upgrade to proceed, for example). In one preferred embodiment, the mode of operation may be to disconnect these disks from the virtual machines, but with the virtual disk images left intact, so that the upgrade may be rolled back.

Some virtual disk images may be preserved, carrying user data across the upgrade. New disk images may be created and populated, as provided in the new OVA. Each of the appliance's disk images may be configured to be attached to their VMs, as specified in the new OVA. User disks may be reattached as per the new OVA as well, using the name of the VDI as the identifier. For example, given the declaration <vbd vdi=“apache-webspace” device=“sda3”/> in the old OVA, and <vbd vdi=“apache-webspace” device=“sda4”/> in the new one, the VDI may be preserved, and attached to the new VM as sda4. All other VM details may be taken from the new OVA, including boot details. Any VMs present in the old OVA but not the new one may be deleted, and any new appearances may be created.

Each of the virtual machines may be launched using the new system filesystems for the post-upgrade phase. The XML-RPC server and logging facility may be available, just as during the install phase, and the appliance may have the opportunity to upgrade user data formats and create any new user filesystems. This phase may continue until every virtual machine has exited. Once the post-upgrade phase is completed, the virtual appliance may start again, this time in the normal boot mode, and the upgrade is complete.

There may be two separate aspects related to uninstalling a virtual appliance. First, user data generated by the virtual appliance may be preserved safely. Secondly, the virtual appliance may be completely removed from the system, including all configuration data installed during the deployment stage. The OVA uninstall tool may prompt the end-user allowing them the option of preserving all the VDIs associated with the virtual appliance or only those containing user data (i.e. those marked variety=“user”). Before uninstall, the virtual appliance may be shut down. If the OVA specifies boot details for the pre-uninstall phase, it may be started up again, using those details. The virtual appliance may run in this phase until every VM has shut down. Once pre-uninstall is over, the virtual disks may be deleted or preserved as per the user's request, and the VMM may clean up all of the metadata associated with that appliance. This completes the appliance uninstall.

Installation and upgrade may be terminated at any time, on the instruction of the user, or due to post-installation or post-upgrade failure as indicated by any of the VMs in the virtual appliance. The installation may be terminated by shutting the VMs down, forcibly if necessary, and then deleting each VM in the virtual appliance. The next step may include cleaning up any temporary state associated with the install. At the user's request, the installer may alternatively leave the VMs intact as best as possible, for debugging. The virtual appliance may ensure the integrity of user data even when the VMs are forcibly destroyed.

There may be a number of scripts or libraries available to aid the creation of OVAs, both in terms of the mechanics of OVA construction and in terms of code to execute within the appliance during post-installation and upgrade. In particular, libraries for interfacing with the VMM over XMLRPC/HTTP may be welcomed by virtual appliance developers. The libraries may also interface with tools for constructing, packaging, and signing appliances automatically.

In a preferred embodiment, the following filesystems may be supported by the OVA compatible installer and the script execution environment, when virtual disk formats are not being used. Compatible installers support creation and mount of these filesystems.

FAT

VFAT

NTFS

ext2

ext3

reiserfs4

ocfs2

ISO 9660

ISO/IEC 13346 (UDF)

The end-user may inspect the OVAs using appropriate tools, without experiencing delay, if the ova.xml file and the manifest are placed at the beginning of the archive. In a preferred embodiment of the present invention, the Zip format may be utilized as a packaging technology. It is contemplated that the Zip format may be utilized for its compression capabilities. The compression used for the Zip is unspecified, and left to the OVA author. No compression may be used (zip −0) and/or the compression of the disk images may be handled by the disk transport formats themselves. Use of Zip files may be limited to 4 GB and may present PKWARE issues.

In another embodiment of the present invention, a tar format may be used. Ordinarily, tar scans the entire archive even if the file requested is found at the front (one may append replacement files to a tarball, without modifying the rest of it). It may be possible to use a modified version of tar for unpacking the OVA that uses the first file that it finds, rather than scanning to the end preserving the tar file format and utilizing standard tar tools for creating OVAs. When using tar, the ova.xml, manifest.txt and signature files can be placed at the front of the archive and may not be duplicated within it. OVAs may be created using standard tools and are in standard format. As a result, the files may be extracted utilizing the same standard tools, but may be extracted faster when using the modified tool.

In a preferred embodiment, the OVA may be implemented as a library of available templates. The library may be accessible through a network or may be included upon a physical media. Networks may include access through the internet, local area networks and others. Physical media may include CD-ROMs and others. The individual templates which carry the configuration and implementation parameters for specific applications may be read only. Alternatively, the templates may have write access that allows for editing and other manipulation of the templates. Additionally, write access may be limited or given to anyone who may access the library.

The library may be implemented as a centralized depository allowing users to access and take what is needed. Alternatively, the library may be variously configured, such as being segmented into numerous regional branches that allow local access and control. Further, the library may be enabled with a user interface that understands the needs of the library and its users as contemplated by those of ordinary skill in the art. For instance, different levels of permissions may be given to different users whereby the access to information and ability to effect editing or other changes may be limited. Each level of permission may be enabled with a different user interface providing various capabilities to the user at their determined permission level. The types and numbers of capabilities enabled at each user interface for each different permission level may vary as contemplated. It is contemplated that the structuring of the library, user interface, permissions, and other features provided by and through the library as contemplated may vary as contemplated by those of ordinary skill in the art.

The templates stored in the library may comprise any number of applications for performance of particular virtual appliances. From the description provided above, an OVA containing and enabling the performance of three different applications by a VMM was shown. It is contemplated that various OVAs may contain less than three or more than three applications, including the configuration and implementation parameters for each application.

As discussed previously, the OVAs are generalized templates of applications. It is contemplated that these general application templates may be modified to produce more specific OVA templates for the functioning of specific applications. This specialization of OVAs may allow for greater functionality to be implemented through the OVAs by the VMMs for particular applications.

The present invention provides a method for configuring an application appliance with an OVA. In a preferred embodiment, an application appliance is built to solve a particular problem utilizing one or more applications embodied in a VM. An OVA containing the “templates” for each of the one or more applications included in the VM is selected. The OVA selected may be installed upon the VMM that may be implementing the application appliance. The VMM, utilizing the templates provided by the OVA, executes the solution provided by the application virtual appliance.

It is contemplated that the OVA selected may be selected from a library that may be accessed over a network, such as the Internet, or from a physical media, such as a CD-ROM. The installation of the OVA may occur as a download over the Internet to the VMM directly. Alternatively, installation of the OVA may occur from a third source, such as the application appliance vendor, provider, consumer. In this situation the OVA may be downloaded from the library or other source as described previously to the third party computing system. The third party computing system may then install the OVA onto the VMM.

In an alternative embodiment, a method of configuring an application appliance with an OVA may include the steps of building the application virtual appliance and packaging it in the OVA format. This packaging of the application virtual appliance with the OVA may then be installed as a single unit onto a VMM. This may further enhance the “plug-n-play” functionality of an application appliance.

The present invention further provides methods of manufacturing an OVA in various ways as may be contemplated by those of ordinary skill in the art without departing from the scope and spirit of the present invention. For instance, an OVA may be constructed upon a physical media. Alternatively, the OVA may be built over a network, such as the Internet, utilizing a site for storage of the information contained within the OVA. Software tools may additionally be provided to facilitate the design, development, and packaging of application appliances into the OVA format.

OVA extensions may be added, however, they may prevent the OVA from working on all VMMs with OVA compatible installers. Extensions may be utilized by the appliance at post-install time, by calling into the XML-RPC server provided by the platform. This may allow the appliance to make its own decisions about compatibility, and may ensure that the appliance be able to fall back to the default behavior if a particular feature is not available.

While the preferred embodiment described above provided an example of the OVA being implemented upon a single VMM. It is contemplated that the OVAs of the present invention be enabled to interact with multiple VMMs, either simultaneously or otherwise. Furthermore, the interaction enabled between multiple OVAs, described previously, enables the present invention to allow such multiple OVA interaction to occur within a multiple VMM framework. As such, the present invention is scalable not only in the number of applications that may be enabled by the OVA, but also in the number of interactions that may be enabled for each OVA during its implementation.

It is believed that the present invention and many of its attendant advantages may be understood by the forgoing description. It is also believed that it may be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A packaging format for a virtual machine, comprising:
an executable instruction set, including virtual machine specific information, for guiding the management of the virtual machine throughout the virtual machine's life cycle.

2. The packaging format of claim 1, further comprising a security feature.

3. The packaging format of claim 2, wherein the security feature is a security verification file including a list of each component of the packaging format and the component's security information.

4. The packaging format of claim 2, wherein the security feature comprises at least one of a manifest.txt, signature.asc, or mf-signature.asc.

5. The packaging format of claim 1, further comprising at least one virtual machine.

6. The packaging format of claim 1, wherein the packaging format is included in at least one of a tar or a zip.

7. The packaging format of claim 1, wherein the executable instruction set is in an xml format.

8. The packaging format of claim 7, wherein the executable instruction set includes instructions for obtaining virtual machine components from specified locations.

9. The packaging format of claim 8, wherein the specified locations are selected from the group consisting of a network location, a file location, an http: location, and an https: location.

10. The packaging format of claim 1, wherein the executable instruction set further comprises directions for at least one of updating or customizing at least one of the packaging format or the virtual machine.

11. The packaging format of claim 1, wherein the executable instruction set is executable by a digital information handling system.

12. The packaging format of claim 1, wherein the life cycle includes four broad stages development, deployment, maintenance, and removal.

13. A method of formatting a virtual machine, comprising:
providing a virtual machine; and
associating the virtual machine with a packaging format, including virtual machine specific information, for guiding the management of the virtual machine throughout the virtual machine's life cycle.

14. The method of claim 13, further comprising creating a security feature and including the security feature within the packaging format.

15. The method of claim 14, wherein the security feature further comprises a security verification file including a list of each component of the packaging format and the component's security information.

16. The method of claim 15, wherein the security verification file further comprises at least one of a manifest.txt, signature.asc, or mf-signature.asc.

17. The method of claim 13, further comprising storing the packaging format in at least one of a tar or a zip.

18. The method of claim 13, wherein the packaging format includes an executable instruction set.

19. The method of claim 18, wherein the executable instruction set is written in xml language.

20. The method of claim 18, wherein the executable instruction set includes instructions for obtaining virtual machine components from specified locations.

21. The method of claim 20, wherein the specified locations are selected from the group consisting of a network location, a file location, an http: location, and an https: location.

22. The method of claim 18, wherein the executable instruction set further comprises directions for at least one of updating or customizing at least one of the packaging format or the virtual machine.

23. An executable instruction set for a packaging format of a virtual machine, comprising:
a first instruction providing a memory for the virtual machine; and
a second instruction providing a location of a source file for the virtual machine.

24. The executable instruction set of claim 23, wherein the memory may be provided as at least one of an integer of a memory size factor, a minimum memory size, a maximum memory size, or a range between a minimum and maximum memory size.

25. The executable instruction set of claim 23, wherein the location may be provided including a virtual block device <vbd> designation, a virtual disk image <vdi> or filesystem <fs> designation, and a mode designation.

26. The executable instruction set of claim 25, wherein the <vbd> specifies the particular <vdi> or <fs> exported to the virtual machine and the mode under which this occurs.

27. The executable instruction set of claim 26, wherein the <vdi> or <fs> specify the location of the source file.

28. The executable instruction set of claim 27, wherein the location of the source file is selected from the group consisting of a network location, a file location, an http: location, and an https: location.

29. The executable instruction set of claim 26, wherein a single <vdi> or <fs> is referenced by multiple <vbd>'s.

30. The executable instructions set of claim 23, wherein the source file is selected from the group consisting of directions for at least one of updating or customizing at least one of the packaging format or the virtual machine, and a security verification file including at least one of a list of each component of the packaging format and the component's security information, a manifest.txt, signature.asc, or mf-signature.asc.
